(19) United States
(12) Patent Application Publication
(10) Pub. No.: US 2026/0298801 A1
(43) Pub. Date: Oct. 1, 2026

(54) OPTICAL FILTERING IN ABSORBANCE DETECTORS

(71) Applicant: Waters Technologies Corporation, Milford, MA (US)

(72) Inventors: Sebastien Besner, Bolton, MA (US); Iain Kanics, Acton, MA (US); Brett G. Cook, Lakeville, MA (US)

(21) Appl. No.: 19/634,805

(22) Filed: Mar. 31, 2026

Related U.S. Application Data
(60) Provisional application No. 63/780,776, filed on Mar. 31, 2025.

(51) Int. Cl. G01N 21/05; G01N 21/03; G02B 5/20; G06K 19/07

(52) U.S. Cl. CPC G01N 21/05; G01N 21/0303; G02B 5/208; G06K 19/0723

(57) ABSTRACT

Disclosed is an absorbance detector that includes a light source, an optical filter, a flow cell configured to hold a sample, and a detector. The optical filter is positioned between the light source and the flow cell. A dispersive element is provided between the light source and the detector. Also disclosed is a flow cell module that includes a module block configured to be connected to a measurement instrument, a flow cell, a filter slot, and a registration feature. The filter slot is configured to receive a filter holder, wherein the registration feature is configured to position the filter holder with respect to the flow cell. Related methods are also disclosed.

### RELATED APPLICATION

This application claims priority to U.S. Provisional Patent Application No. 63/780,776 filed Mar. 31, 2025, the entirety of which is incorporated by reference herein.

### FIELD OF THE INVENTION

The disclosed technology relates generally to an absorbance detector. More particularly, the technology relates to an absorbance detector using an optical filtering element to improve instrument linearity and reduce sample photodegradation.

### BACKGROUND

Liquid chromatography systems are used to perform chemical separations. A typical liquid chromatography system includes the following major components: a pump, an injector, a chromatography column, and a detector. The pump provides a mobile phase, for example, a solution comprising one or more solvents, through a fluid path that includes the injector, column and detector. The injector enables the introduction of a sample into the mobile phase upstream from the column. The column contains a packed bed of media. The media is normally porous and relatively inert. Each compound in the sample exhibits a characteristic affinity to the media and elutes as a band from the column at a time dependent on its affinity for the media. The bands are detected over time by the detector.

Absorbance detectors play a crucial role in high-performance liquid chromatography (HPLC). Absorbance detectors work by directing either a broad-spectrum light or light of limited bandwidth through a sample. The light that passes through the sample is then measured by a detector at specified analytical wavelengths, providing valuable information about the concentration of an analyte in the sample. The analyte concentration is derived from Beer's Law, A=εlc, where A is absorbance, F is the molar extinction coefficient, 1 is the length of the path light must travel in the solution, and c is the concentration of a given analyte. The molar extinction coefficient depends on the nature of the chemical and the wavelength of the light used. For this reason, analyte quantitation is typically performed at a specific and narrow wavelength bandwidth corresponding to a spectral absorption maximum of the analyte. The absorption spectrum, albeit not highly specific, can provide some information about the sample identity. While the light absorption provides useful information about the sample, it can also result in photodegradation for photosensitive compounds.

When the absorbance detector is configured with a photodiode array (PDA), broadband light is typically used. Such broadband light will include wavelengths outside the absorbance band that provide no useful information for an analyte but contribute to stray light. Further, very high sample light exposure from broadband light, including, for example, ultraviolet (UV) light, can result in photodegradation of the sample and/or analytes therein.

For a single or tunable wavelength detector, the light emitted from a broadband light source is typically filtered using a monochromator placed prior to the sample. Such an approach minimizes potential photodegradation by removing most of the light not being used for quantification. This is especially important when serial detection is used or when the sample is collected, and the integrity must be maintained. In such design, the stray light resulting from the finite monochromator extinction ratio has limited impact on photodegradation but can impact the linearity at the higher absorbance range by restricting the minimal amount of light being measured.

Photodiode arrays (PDA), also known as diode array detector (DAD), are typically used when several wavelengths of interest must be acquired in real time. The broadband light in such a detector is first transmitted to the sample, then dispersed, and recorded on a series of photodiodes. For chromatographic systems, the flow cell volume required to maintain the chromatographic resolution must be appropriately small and the light emitted by the broadband source must be collected and focused within the optical volume to maximize the optical throughput. This results in very high sample light exposure which can lead to unwanted photodegradation. Typical approaches to minimizing the sample photodegradation are to reduce the light dosage by adding neutral density filters or reduce the aperture (or etendue) of the optical system prior to the flow cell. While effective in reducing the relative photodegradation amount by reducing the intensity of the light, the indiscriminating nature of the approach directly translates to an increase in the absorbance noise by reducing the intensity of the light reaching the detector at the measurement wavelengths.

An important measure used to quantify and compare the light stability of different compounds is the quantum yield of photodegradation. This is defined as the ratio of the number of absorbed photons that cause a molecular reaction to the total number of photons absorbed. A high quantum yield indicates a high probability of a reaction occurring after photon absorption. Conversely, a low quantum yield means that there is a lower likelihood of a reaction taking place, and the absorbed energy is more likely to be released as heat or other physical phenomena.

Therefore, optical filtering in absorbance detectors that provide for selective elimination of wavelengths associated with high photodegradation quantum yield while retaining the intensity of the light at wavelengths of interest would be well received in the art. Likewise, optical filtering that provides elimination of light emitted at wavelengths not being absorbed by the analyte (and therefore not providing any relevant information) to reduce the stray light and increase the linear range of the instrument would be well received in the art.

### SUMMARY

In one embodiment, an absorbance detector comprises a light source, an optical filter, a flow cell configured to hold a sample, and a detector, wherein the optical filter is positioned between the light source and the flow cell, and wherein a dispersive element is provided between the light source and the detector.

Additionally or alternatively, the absorbance detector further comprises a filter holder for holding the optical filter.

Additionally or alternatively, the filter holder and/or the filter includes a filter ID chip configured to provide filter identification information regarding the filter.

Additionally or alternatively, the filter ID chip comprises an electrical connector configured for coupling to a further electrical connector to enable the filter identification information to be read from the filter ID chip.

Additionally or alternatively, the filter ID chip is a radio frequency identification (RFID) chip and wherein the filter identification information is stored on the RFID chip.

Additionally or alternatively, the dispersive element is a diffraction grating and/or wherein the filter is an ultraviolet blocking filter, a bandpass filter, a longpass filter, a shortpass filter, or a neutral density filter.

Additionally or alternatively, the filter holder and filter form a filter module.

Additionally or alternatively, the filter module is removeable from the absorbance detector and/or the flow cell module.

Additionally or alternatively, the absorbance detector further comprises a filter slot for receiving the filter holder and/or the filter.

Additionally or alternatively, the flow cell is configured to pass a liquid chromatography system flow.

In another embodiment, a method of measuring absorbance of a sample comprises providing an optical beam having a spectrum, providing a filter, providing a flow cell module with a sample, positioning the filter in an optical axis of the optical beam prior to the sample, and filtering the optical beam using the filter to generate a filtered optical beam having at least one of a reduced spectral width and an attenuated intensity of the optical beam, wherein the method further comprises dispersing the optical beam, and receiving the optical beam at a detector.

Additionally or alternatively, filtering the optical beam comprises one or more of bandpass filtering, shortpass filtering, longpass filtering, neutral density filtering, and linear variable edge pass filtering.

Additionally or alternatively, spectrally dispersing the filtered optical beam comprises directing the filtered optical beam to be incident on a diffraction grating.

Additionally or alternatively, filtering provides reduced photodegradation of the sample and/or provides improved linearity of measured absorbance.

Additionally or alternatively, the method further comprises providing filter identification information from the filter and/or a filter holder holding the filter.

In a further embodiment, a flow cell module comprises a module block configured to be connected to a measurement instrument, a flow cell, a filter slot, and a registration feature, wherein the filter slot is configured to receive a filter holder, and wherein the registration feature is configured to position the filter holder with respect to the flow cell.

Additionally or alternatively, the flow cell module comprises the filter holder and at least one filter, wherein the filter holder is removeable from the filter slot and/or wherein the filter holder holds a plurality of filters and the at least one filter is selectable from the plurality of filters.

Additionally or alternatively, the filter holder comprises a filter ID chip for providing information about the filter holder and/or the at least one filter.

Additionally or alternatively, the flow cell comprises a flow cell ID chip for providing information about the flow cell.

Additionally or alternatively, the registration feature is a rail for guiding the filter holder when the filter slot receives the filter holder.

### BRIEF DESCRIPTION OF THE DRAWINGS

The above and further advantages of embodiments of the invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1A is a schematic overview of optical elements for conventional single wavelength detection.

FIG. 1B is a schematic overview of optical elements for two-stage single wavelength detection in accordance with embodiments of the invention.

FIG. 1C is a schematic overview of optical elements for conventional multiple wavelength detection.

FIG. 1D is a schematic overview of optical elements for two-stage multiple wavelength detection in accordance with further embodiments of the invention.

FIG. 2A depicts an absorption spectrum of a caffeine sample showing typical regions of interest.

FIG. 2B depicts an extracted chromatogram of the caffeine sample obtained on an HPLC instrument at different wavelengths.

FIG. 3 depicts an absorption spectrum along with measured and expected signal of a blank and a caffeine solution of 0.1 mg/mL

FIG. 4A depicts an absorption spectrum of a caffeine sample using a bandpass filter in accordance with embodiments.

FIG. 4B depicts an absorption spectrum of a caffeine sample using a shortpass filter in accordance with embodiments.

FIG. 4C depicts an absorption spectrum of a caffeine sample using a longpass filter in accordance with embodiments.

FIG. 5A depicts signal recorded with and without the use of a 206 nm bandpass filter in accordance with embodiments.

FIG. 5B depicts respective linear ranges of measurement for a caffeine sample at 205 nm with and without the 206 nm bandpass filter in accordance with embodiments.

FIG. 6A depicts absorbance vs concentration curve for caffeine at 273 nm for different shortpass filters in accordance with embodiments.

FIG. 6B depicts absorbance error against a linear model for caffeine at 273 nm for different shortpass filters in accordance with embodiments.

FIG. 7A compares relative absorbed light dosage for protein (mAB) for different longpass or bandpass filters in accordance with embodiments.

FIG. 7B compares relative absorbed light dosage for nucleic acid (ssDNA) for different longpass or bandpass filters in accordance with embodiments.

FIG. 8A depicts a front side perspective view of a flow cell with an optical filter in accordance with embodiments.

FIG. 8B depicts a rear side perspective view of the flow cell with the optical filter of FIG. 8A in accordance with embodiments.

FIG. 9 depicts a method of measuring absorbance in accordance with embodiments.

### DETAILED DESCRIPTION

Reference in the specification to an embodiment or example means that a particular feature, structure or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

In brief overview, embodiments of the present invention use an optical filter to improve the linearity range of an absorbance detector and/or to limit the photodegradation of photosensitive analytes. Embodiments can be used with a single or tunable wavelength detector or a photodiode array detector. In embodiments, the optical filter reduces the optical bandwidth of broadband light sources such that spectral irradiance of the light source matches a target measurement and, at least partially, an absorption spectrum of analytes under study. In some embodiments, a wavelength rejected by the optical filter may include regions of high absorbance and high quantum yield for photodegradation to maintain the sample integrity. In some embodiments, the wavelength rejected by the optical filter includes regions of low to no absorbance to limit the amount of stray light reaching the detector. The optical filter can also transmit a single narrow bandwidth to match specific absorption features of the analyte to minimize any unwanted light-interaction or parasitic light in embodiments. Owing to the large variety of samples analyzed in chromatography, or by absorbance detection in general, embodiments include designs where the optical filters can be easily replaceable by an end user and/or can be selectable from a series of pre-available filters via manual interaction or motorized actuation. Embodiments also include features and methods to detect and identify (for example, automatically) the filters to maintain good traceability and optimize detector performance.

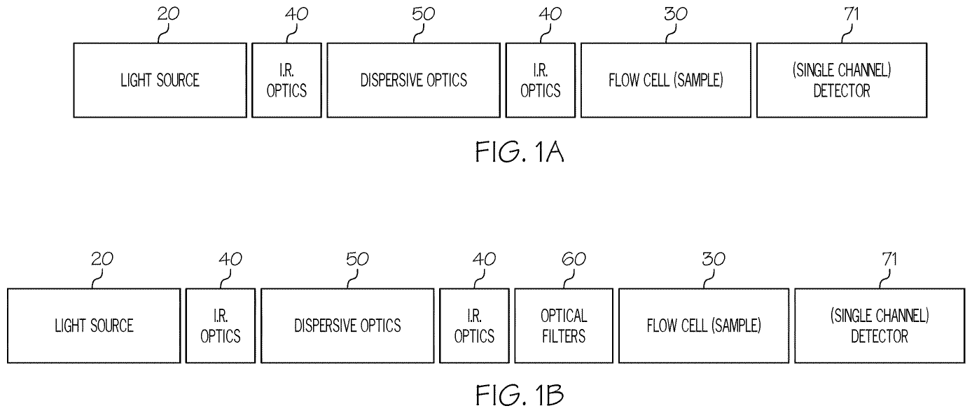

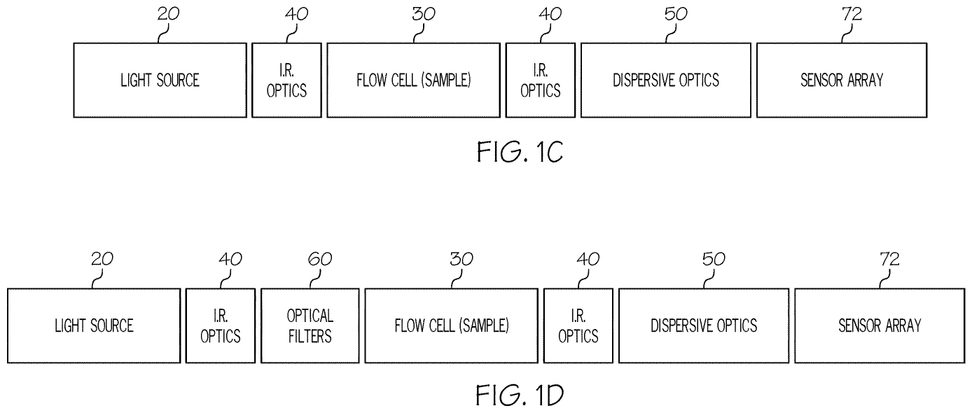

FIGS. 1A and 1C provide schematic overviews of main building blocks and respective order for single wavelength (or tunable) detectors (FIG. 1A) and multiple wavelength detectors such as a photodiode array detector (PDA) (FIG. 1C). I.R. Optics refer to imaging relay optics and can comprise of mirror of lens elements with the purpose of transfering an intermediate image from one plane to another, essentially coupling the optical output of one subsystem into the input of the following one.

FIGS. 1B and 1D provide schematic overviews of main building blocks and respective order for single wavelength (or tunable) detectors (FIG. 1B) and multiple wavelength detectors such as a photodiode array detector (PDA) (FIG. 1D) having an optical filter 60 in accordance with embodiments. Such embodiments may also be referred to as two-stage detection.

As depicted therein, in embodiments the optical filter 60 is positioned between the light source 20 and the sample 30, i.e., between the light source 20 and the sample 30. As discussed in more detail below, in embodiments, the optical filter 60 may include additional structure, for example, a filter holder and/or other components. Still further, the optical filter 60 may be removeable and/or selectable from a plurality of filters.

Referring first to FIGS. 1A and 1C, an absorbance detector 10 includes a light source 20 that provides light into and through a flow cell or cuvette 30. The flow cell or cuvette 30 contains a sample, and may also be referred to herein as the sample 30. The light source 20 can be any light source capable of providing light of an appropriate spectrum, intensity, and stability, e.g., a deuterium, tungsten, xenon lamp, or broadband LED.

The light emitted from the light source 20 is typically collected and refocused by using various types of focusing lenses or reflectors (Imaging Relay [I.R.] Optics) 40. To have an optimized throughput, the etendue of the light source, the collecting optics and the receiving optics must closely match. The etendue describes the ability of a source to emit light or the ability of an optical system to accept light. For a monochromator or a spectrophotometer, the etendue of accepting light is a function of the entrance slit area times the solid angle from which light is accepted. In an absorbance detector, the limiting etendue is typically set by the sample and the etendue of the remaining optical components are selected accordingly.

For single wavelength detection, dispersive optics 50 constituting the monochromator are generally placed before the sample, i.e., before the flow cell or cuvette 30 as shown in FIG. 1A, and only the wavelength of interest for the measurement interacts with the sample. Dispersive optics 50 may include, for example, a diffraction grating. An exemplary detector is the Acquity UPLC TUV Detector produced by Waters Corporation of Milford, MA. Such detector uses a Fastie-Ebert configuration where a portion of a large mirror first collimates the light which will fall upon the plane grating and a second portion of the same mirror then focuses the dispersed light from the grating into images of the entrance slit in the flow cell. This type of configuration minimizes the light dosage and photodegradation as light emitted from the light source 20 is pre-filtered prior to the flow cell or cuvette 30 and thus prior to the sample. This layout is generally preferred when UV detection is coupled with a second detector, such as a mass spectrometer.

In multiple wavelength detection, the light emitted from the light source 20 must be allowed to interact with the sample 30 as shown in FIG. 1C to get any relevant sample-related response. In this case, the complete emission spectrum of the source is transmitted to the sample 30 and the dispersive element 50 is placed after the flow cell 30 to separate the different wavelengths on a sensing array such as a photodiode array or a CCD. An exemplary detector is the Acquity UPLC PDA Detector produced by Waters Corporation of Milford, MA. In such an instrument, the light emitted from the source 20 is first refocused at an entrance to the flow cell 30 using an off-axis ellipsoidal mirror. The light exiting the flow cell 30 is refocused a second time at an entrance slit of the spectrometer and then dispersed onto a photodiode array by a flat field imaging grating. While enabling the complete absorbance spectrum to be recorded simultaneously, that configuration significantly increases the light dosage at the sample 30 and propagates wavelengths that may be outside the absorbance region. The increase in the light dosage, especially at the lowest wavelength, can promote the photodegradation of light-sensitive compounds in the sample 30. Furthermore, the wavelengths outside the absorbance band provide no useful information but increase the amount of stray light and limit the linear range of the instrument.

These problems can be mitigated by adding an optical filtering element such as optical filter(s) 60 between the light source 20 and the sample 30 as shown in FIGS. 1B and 1D. As mentioned above, these embodiments may also be referred to as two-stage detection.

The operation and use of devices having such optical filter(s) and/or using such two-stage detection is discussed in more detail below and is compared with conventional operation and conventional devices.

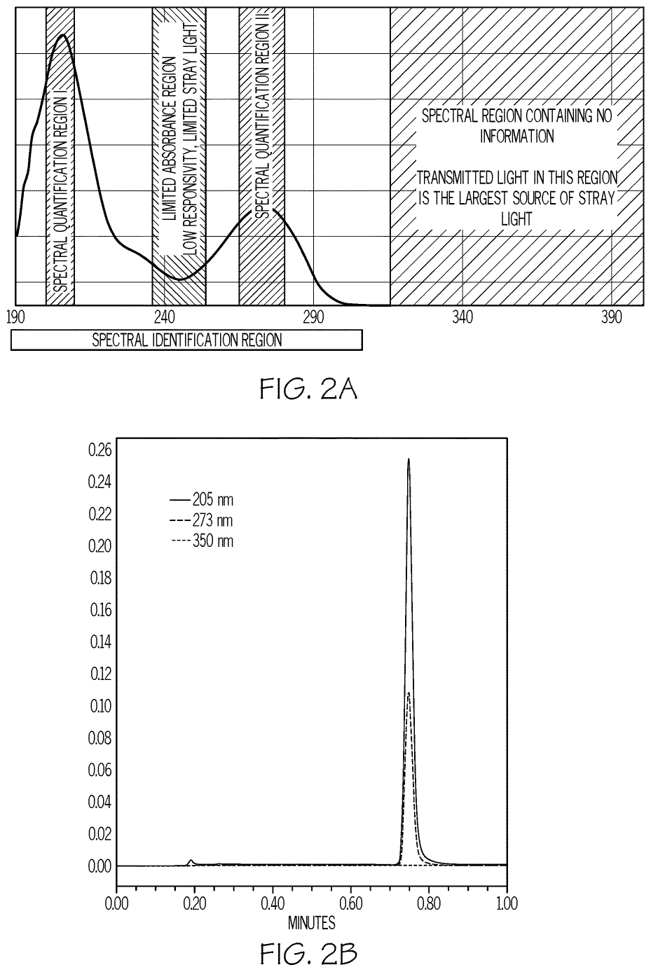

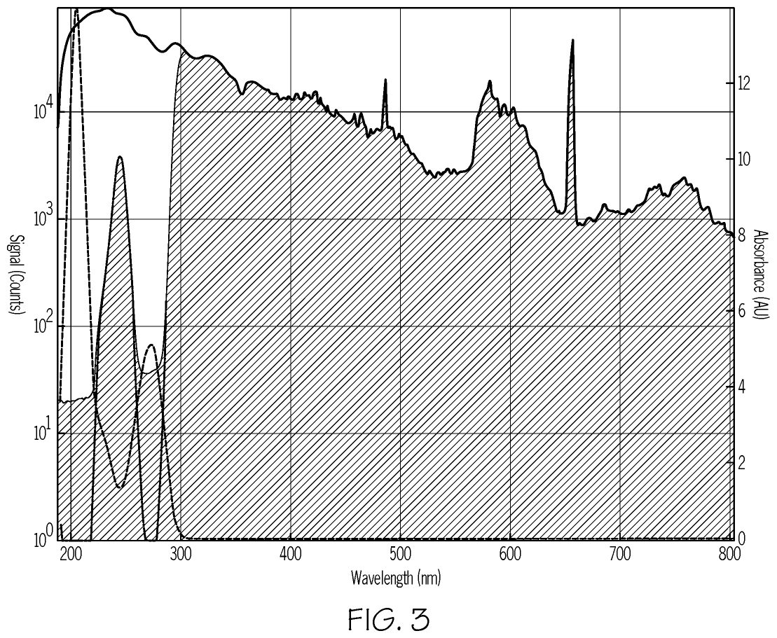

First, FIGS. 2A, 2B, and 3 depict conventional experimental results obtained for a common analyte, caffeine, for comparison with embodiments of the invention.

FIG. 2A depicts an absorption spectrum and identifies different regions of the common analyte, caffeine. The region with a significant absorbance (the absorption spectrum) provides information about the identity and concentration of the analyte. In absorbance detectors, the spectral analysis is often utilized to identify unknown components, to deconvolve the response of different analytes, or to establish the purity of a single chromatographic peak. In contrast, quantification typically relies on the peak integration at a single extracted wavelength. The selected wavelength will affect the detector response as it relates to the constituent extinction cross-section and the baseline noise and drift. The best wavelength for analysis typically aligns with the absorption spectrum maxima (spectral quantification region I and II in FIG. 2A), regions associated with the largest response, smallest wavelength sensitivity, and best linearity.

While many compounds will show some absorbance in the low UV wavelength (good sensitivity, low specificity), a much more limited number of compounds exhibit absorbance in the visible range (higher specificity but infrequent usage). In embodiments, the light propagating outside the sample optical volume but reaching the detector can generally be neglected. A major source of stray light comes from the light interacting with the sample optical volume in spectral regions with limited to no absorbance (area to the right in FIG. 2A). The light collected in these regions will add limited to no additional information but will limit the maximum absorbance that can be measured at other wavelengths of interest due to stray light generated within the spectrophotometer.

FIG. 2B depicts chromatograms extracted from the simultaneous spectral acquisition at a wavelength of 205 nm, 273 nm, and 350 nm for the caffeine sample of FIG. 2A. The 205 nm wavelength offered the largest response but showed a poorer baseline stability, especially noticeable at around 0.2 min. This instability results from interference either due to a mismatch between the diluent and the mobile phase or contamination in the sample or mobile phase. The 273 nm wavelength has a smaller response but may be selected due to its improved baseline noise and drift which result in an overall better SNR. The 350 nm wavelength is outside the absorbance band of caffeine and provides no sensitivity.

FIG. 3 shows a collected signal from a deuterium lamp in a photodiode array instrument (solid line), the collected signal for a 0.1 mg/mL caffeine solution (shaded area), the absorbance spectrum of a caffeine solution at 0.1 mg/mL (heavy dashed line), and the expected signal level derived from a perfect Beer-Lambert law for a 0.1 mL/mg caffeine solution (dash dot line). As can be seen from the figure, the region associated with an absorbance smaller than about 2.5 AU is accurately measured by the instrument. However, deviation above this threshold becomes larger as the minimal signal measurable is limited by stray light rather than the sample absorbance. That stray light comes from light being transmitted by the sample but improperly dispersed or filtered out by the imaging spectrophotometer. It is generally limited by the grating imperfection and improved by the proper management of the reflection of the different orders within the spectrophotometer enclosure. For most broadband light sources, like a deuterium or xenon lamp, the emission extends much farther than the absorbance band of the analyte and is contributing to the amount of stray light measured at the lower wavelengths. Regions of low absorbance will also contribute to stray light if the residual signal remains strong at the target concentration range (see for example the area around 245 nm for caffeine in FIG. 3).

A single-stage monochromator typically has a stray light percentage ranging from 0.01%-0.2%; meaning that between 1/10,000th and 1/5,000th of the light reaching the detector is from wavelengths outside the selected band. For a double stage monochromator, the stray light percentage is generally, in the 0.001%-0.01%. While a double stage monochromator can measure a sample with higher light absorbance, the increased size and decrease in optical throughput or sensitivity can be design limiting factors, especially for chromatographic separation where the data rate must be maintained large.

When comparing the ideal Beer-Lambert model (Eq. 1) with the stray light model (Eq. 2), one can see that the error reported on the measured absorbance will increase with the decrease of the initial light level at the wavelength of interest (I₀) and the increase of stray light coefficient (sₗ) and the light level at other wavelengths (Iₗ):

$$A = {log}_{10} ( \frac{{I}_{ref}}{{I}_{sample}} ) = {log}_{10} ( \frac{{I}_{O}}{{Ie}^{- α cl}} ) = 0.4343 α cl \qquad ( 1 )$$

$$A = {log}_{10} ( \frac{{I}_{O} + \sum {s}_{λ} {I}_{λ}}{{I}_{O} {e}^{- α cl} + \sum {s}_{λ} {I}_{λ}} ) = {log}_{10} ( \frac{{I}_{O} + {sI}_{O}}{{I}_{O} {e}^{- α cl} + {sI}_{O}} ) = {log}_{10} ( \frac{1 + s}{{e}^{- α cl} + s} ) \qquad ( 2 )$$

While the intensity and stray light coefficient are wavelength dependent, it is customary to sum up all contribution into a single stray light coefficient, s, defined as the ratio of stray light relative to the initial light level of the measurement wavelength. At high concentration, that coefficient limits the maximum absorbance value measured to log 10(1+s/s). To improve the linearity range, either the intensity of the light at the measurable wavelength (I₀) can be increased, the stray light coefficient (sₗ) can be decreased, or the intensity of the light related to the stray light (Iₗ) can be decreased. The light output is dictated by lamp emissivity and typically cannot easily be increased at will. The stray light coefficient is also limited by the spectrometer and grating design and rarely decreases below 0.05% for an imaging spectrometer. This would limit the maximum absorbance measurable to about 3.3 AU. However, in embodiments, the intensity of the light outside the wavelengths of interest can be rejected with optical filters such as those disclosed herein without significantly impacting the light transmission at the wavelength of interest or increasing the size or complexity of the instrument. Further, optical filters such as those described herein can also be used to mitigate photodegradation and extend the linearity range.

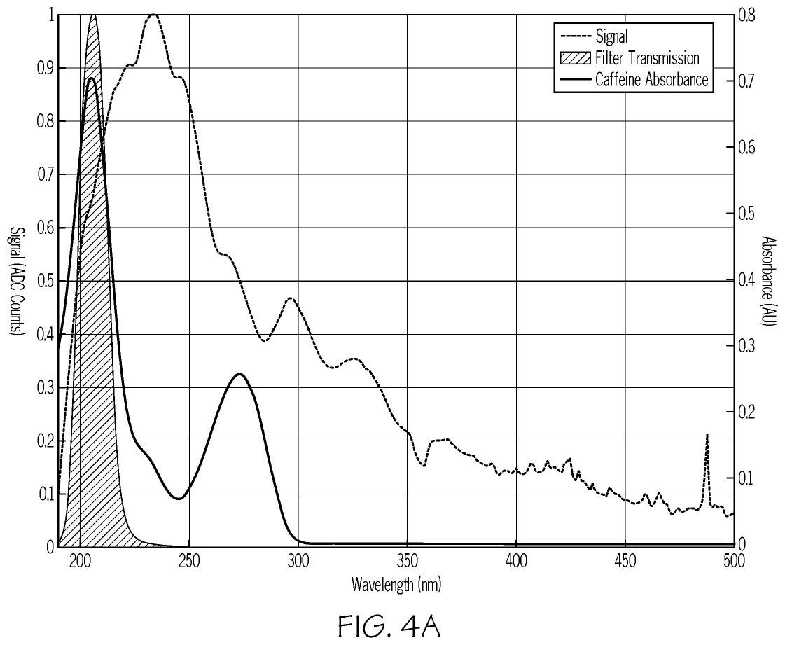

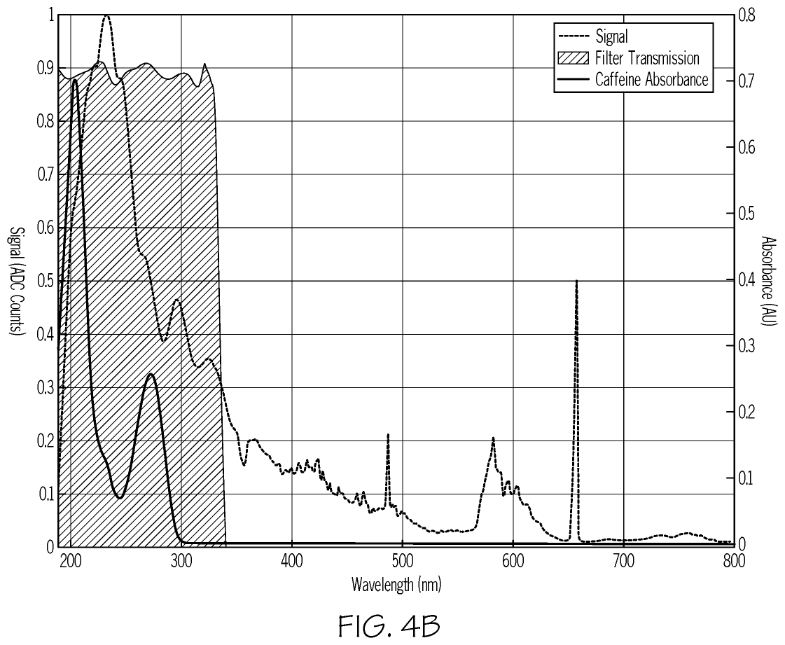

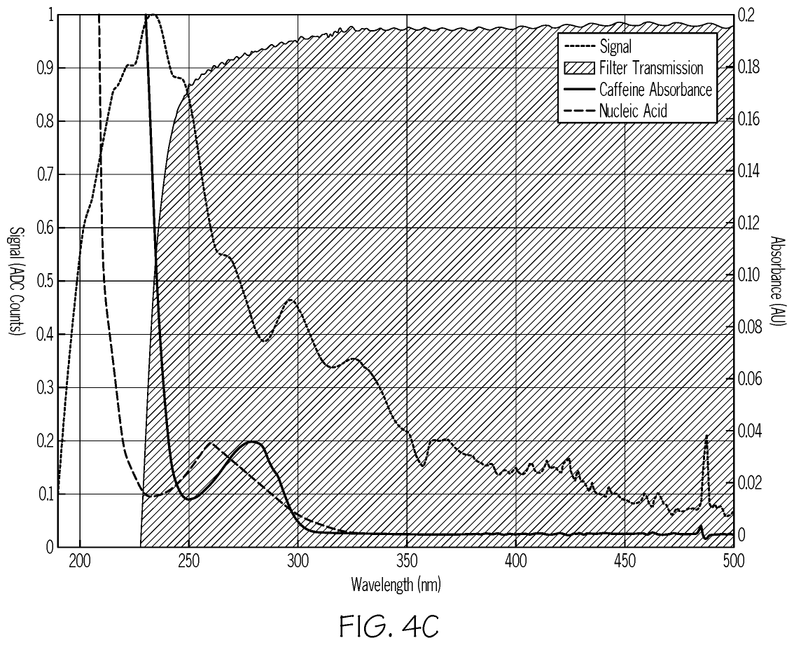

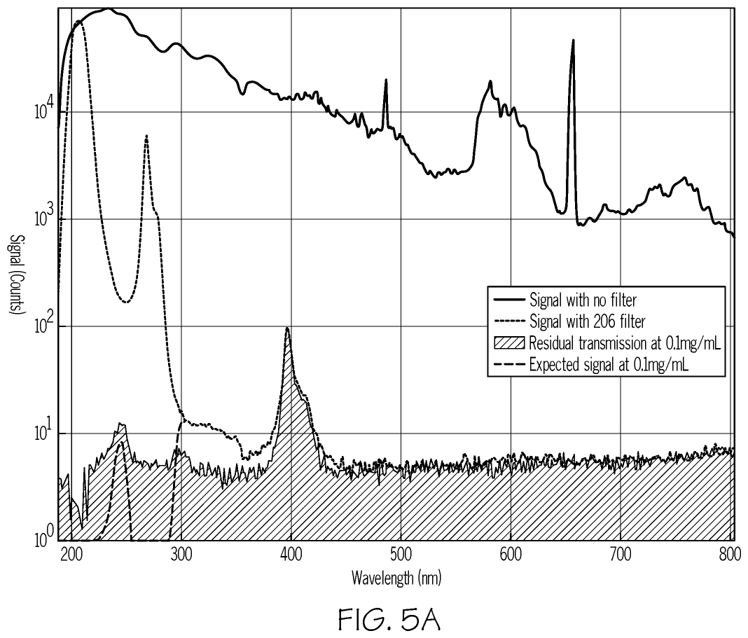

In embodiments, an optical filter such as those described herein limits the spectrum of the light emitted by the light source to a predefined spectral range. In embodiments, for example as shown in FIG. 4A, the optical filter may be a narrow bandpass filter that has a narrow spectral width. By way of a non-limiting example, the optical filter may be an optical thin film filter having a bandwidth of approximately 10 nm. Such a filter is beneficial for embodiments in which the illumination of the flow cell is limited to a narrow spectral band that includes a known absorption wavelength for an analyte to be detected. In embodiments, such a configuration can significantly reduce the UV light dosage received by the sample by filtering out the wavelengths not essential for the quantitative analysis without affecting the transmission at the wavelength of interest and therefore, the signal to noise ratio. Referring still to FIG. 4A, the bandpass filter could be tuned at the 205 nm center wavelength or to a longer 273 nm center wavelength if the compound was photosensitive. An intrinsic characteristic of the bandpass filter is also maximizing the linearity range by maintaining the initial intensity, I₀, high and minimizing the terms I₁ in equation 2. Advantageously, UV light from the light source is substantially reduced or eliminated from reaching the flow cell and therefore UV photodegradation of the sample is nearly or completely eliminated. In these embodiments, the use of a narrow bandpass filter converts a single stage PDA spectrophotometer into a two-stage fixed wavelength monochromator with high throughput, reduced stray light level, and reduced photodegradation.

Alternatively, in embodiments the optical filter can be a shortpass filter with a cut-off wavelength tuned to allow the transmission of the light in the region where the sample exhibits some absorbance and to block the light at longer wavelength as shown in FIG. 4B. In embodiments, this configuration maintains the full spectral resolution capability of the instrument and improves the instrument linearity by filtering the light emitted by the broadband light source before it reaches the dispersive element, for example, spectrophotometer, and contributes to stray light. FIG. 4B exemplifies such a filter where the cut-off wavelength is selected to transmit light overlapping with the absorption spectrum of the analyte. A convenient cut-off wavelength in many embodiments would lie between 300-400 nm as most compounds absorb at a wavelength lower than this threshold but not above.

Referring now to FIG. 4C, in embodiments other types of optical filters can be longpass filters tuned to block the deep UV light being strongly absorbed by the sample while allowing light to be transmitted at higher wavelength to provide adequate spectral analysis. In embodiments, such filters limit the photodegradation of photosensitive samples. Biomolecules such as oligonucleotides, RNA, DNA, peptides, and proteins are examples of such molecules. Peptide bonds, because of their carbonyl groups, absorb light energy at very short wavelengths (185-200 nm). The exposure to the light in the 185-200 nm range can also lead to significant degradation, including oxidation, fragmentation, and aggregation. The higher energy associated with shorter wavelength photons also promotes the generation of reactive oxygen species, which can attack and modify the biomolecules, leading to degradation. The A260/A280 ratio provides insight regarding the type of nucleic acid present (dsDNA or RNA) as well as providing a rough indication of DNA or protein purity. A ratio of about 1.8 is generally considered pure for DNA, while a ratio of 0.6 is considered ideal for proteins. The A260/A230 ratio is also a sensitive indicator of contaminants that absorb at 230 nm. These contaminants are significantly more numerous than those absorbing at 280 nm. In common laboratory practice, DNA and RNA samples with A260/A280 and A260/A230>1.8 are considered “clean”, and suitable for use in most downstream applications.

An example absorption spectrum using such a filter is depicted in FIG. 4C. The cut-off wavelength of 220 nm minimizes the potential for photodegradation while still allowing adequate spectral analysis of the ratios discussed above. Removing the strongest UV emission of the broadband light source with a longpass filter would also significantly reduce the amount of stray light for compounds absorbing mostly in the UVA/B-Visible regions and improve detector linearity.

In further embodiments, a neutral density filer can be used to reduce the light level at the flow cell to thereby decrease the level of photodegradation. In this example, the full spectrum measurement capability enabled by the PDA are retained; however, the relative number of photo-degraded molecules is less in proportion to the light dosage. Such embodiments would be useful for cases where the SNR of the analysis is far greater than what is needed for the characterization of the analyte and where a decrease in the light throughput and associated decrease in SNR would be favored to limit potential photodegradation.

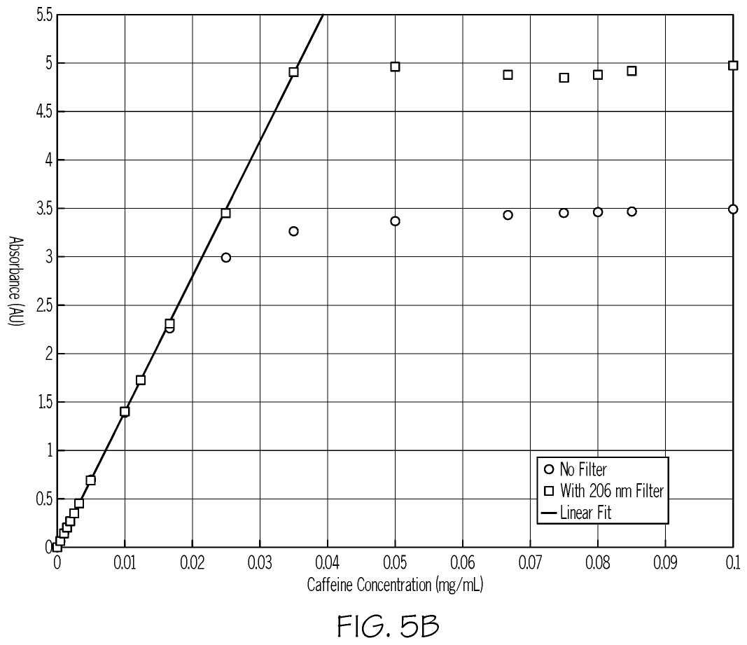

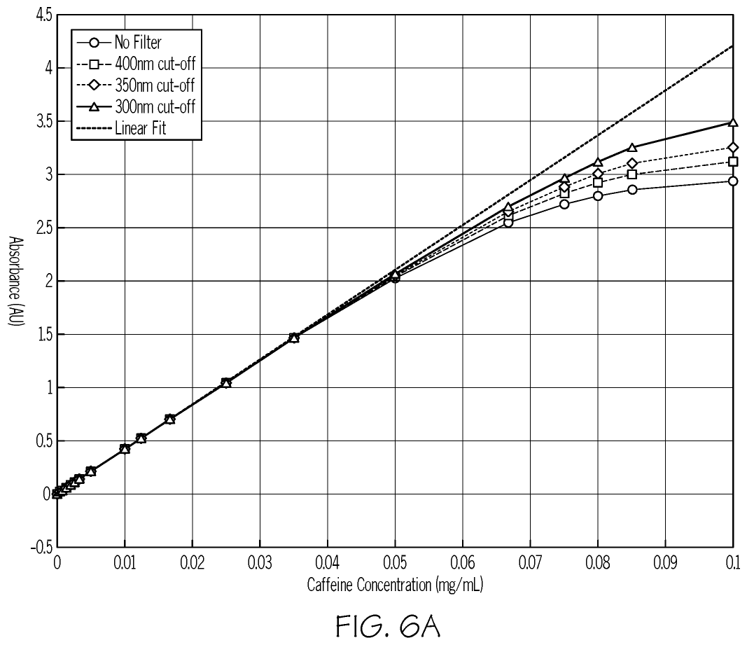

FIGS. 5A and 5B depict implementation of a narrow 206 nm bandpass filter in accordance with embodiments. FIG. 5A shows the light recorded on the PDA for a blank with no filter (thick line), the light recorded on the PDA for a blank with the 206 nm filter (dashed line), the residual transmission for a 0.1 mg/mL solution of caffeine (shaded area), and the expected signal at 0.1 mg/mL for the same caffeine concentration (dotted line). The bandpass filter can effectively remove most of the intensity of the light outside the selected band around 205 nm. This effectively removes all of the potential wavelengths that could be contributing to stray light and effectively transforms the PDA detector into a double-stage single wavelength monochromator. A residual count of 20-50 was recorded without the bandpass filter (FIG. 3). With the bandpass filter, the residual count was less than 2 counts at 205 nm and less than 5 counts elsewhere (FIG. 5A).

As shown in FIG. 5B, the elimination of the stray light allows an absorbance measurement up to 5 AU, at which point measurement is limited by the dynamic range of the instrument/electronics rather than the stray light itself. From the absorbance curve, it is estimated that the addition of the bandpass filter decreased the stay light coefficient from s=0.26% to less than s=0.001%.

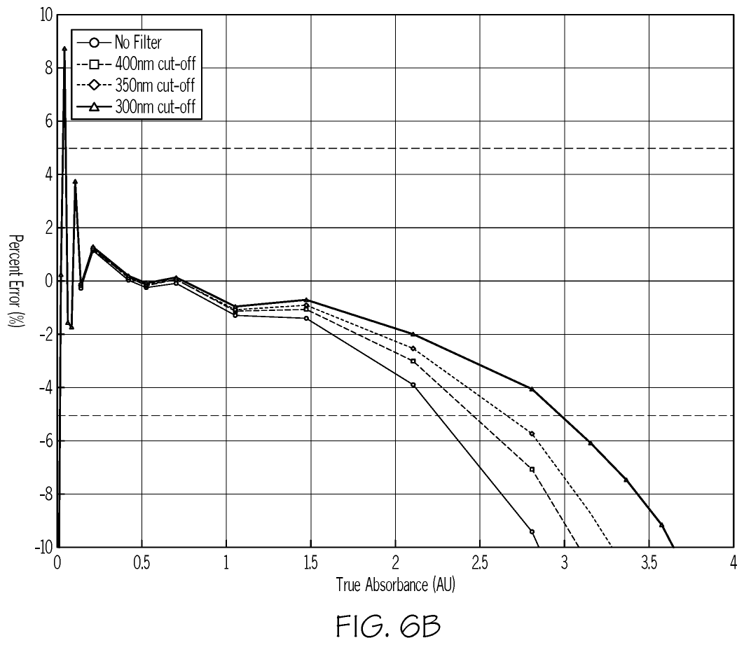

Similarly, FIGS. 6A and 6B illustrate the impact of optical shortpass filters with respective cut-off wavelength ranging from 400 nm to 300 nm on the absorbance accuracy of a caffeine solution. In the depicted cases, the cut-off wavelength was higher than the absorption feature of caffeine and each filter was simply removing an increasingly larger portion of the light emitted by a deuterium lamp and not being absorbed by the sample. The measured absorbance is provided in FIG. 6A, while the absorbance error defined as the relative difference between the measured absorbance and the linearly extrapolated absorbance from point with absorbance lower than 1 AU is shown in FIG. 6B. In the depicted embodiments, the addition of the optical shortpass filters improved the linearity range as the cut-off wavelength decreased toward the edge of the caffeine absorbance and allowed an increase at a 5% accuracy range by up to 0.75 AU with a 300 nm cut-off filter without affecting the spectral resolution capability of the instrument.

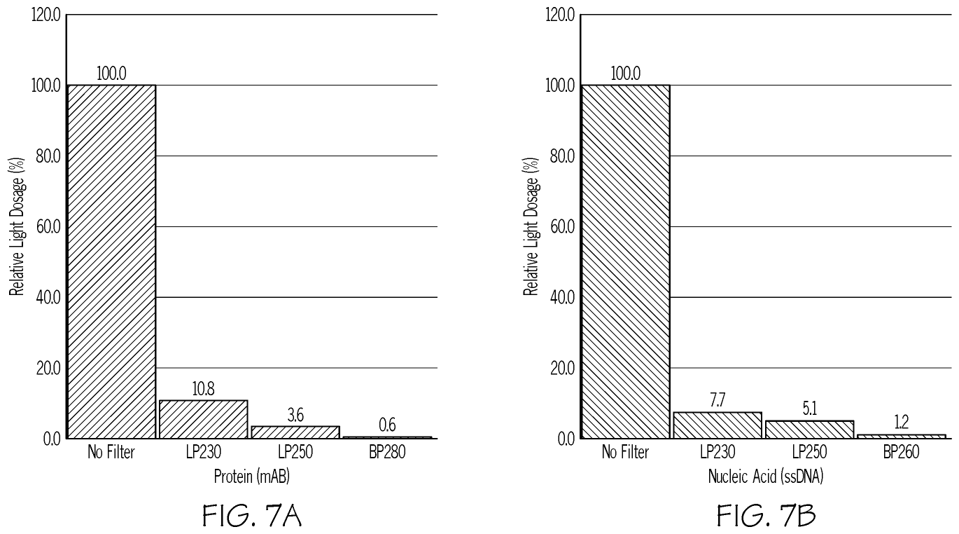

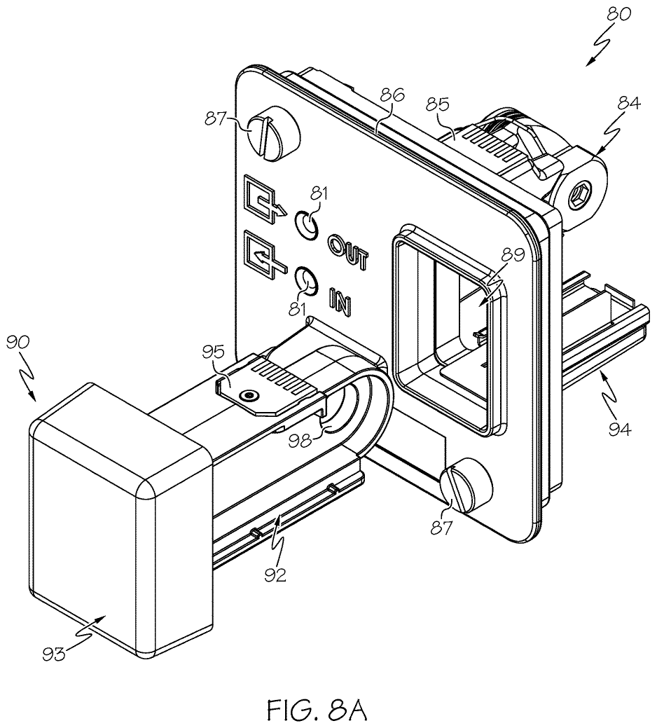

FIGS. 7A and 7B reports the relative total light dosage absorbed by proteins (mAB) and nucleic acid (ssDNA) when irradiated with a deuterium lamp filtered with various optical filters placed prior to the flow cell in accordance with embodiments. The light dosage is calculated from the deuterium lamp spectral irradiance and the measured absorption spectra of the analytes. A longpass (LP) filter allows the spectral characterization above the cut-off wavelength while minimizing the degradation via oxidative processes associated with high energy photons. For example, a 230 nm longpass filter would allow the analysis of the 260/230 nm and 280/260 ratios, while a 250 nm longpass would allow the analysis of the 280/260 ratio and associated spectral characteristics. A bandpass (BP) filter would minimize the photodegradation but essentially convert the PDA into a single wavelength detector. The absorbed light dosage decreases by a factor of 9-13, 20-28, and 83-166 for the 230 nm, 250 nm longpass filters and the bandpass filter, respectively.

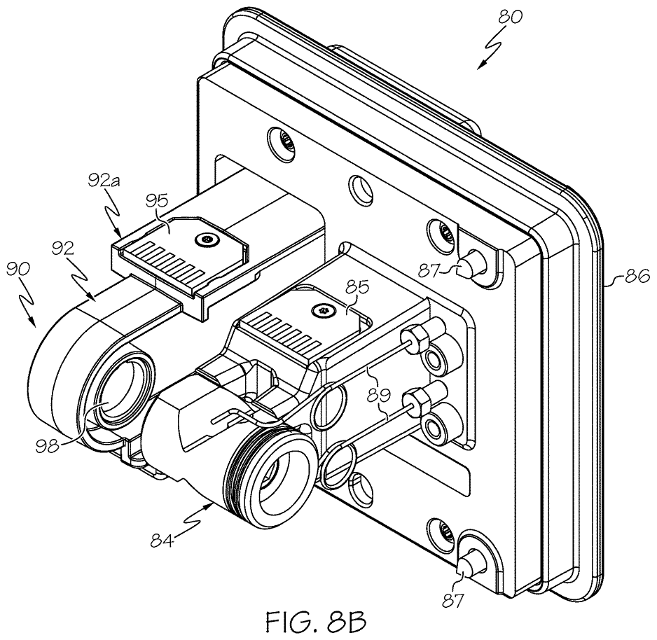

As discussed above, selection of an appropriate optical filter may allow for improved instrument linearity, reduced sample photodegradation, and other benefits. Embodiments of the present invention provide optical filters that are removeable, exchangeable, selectable, or the like. Accordingly, a user may select an appropriate optical filter for an instrument, for a sample, for a specific analyte, and the like. FIG. 8A and FIG. 8B depict embodiments of devices allowing for user selection of an appropriate optical filter. FIG. 8A depicts a front side perspective view of an embodiment of a flow cell module 80 of a detector/measurement instrument. FIG. 8B depicts a rear side perspective view of the flow cell module 80 of FIG. 8A.

As shown, the flow cell module 80 may generally comprise a module block 86 that can be attached a part of the measurement instrument, such as an instrument wall or mounting surface, for example using fasteners 87. In embodiments, the instrument may be or may include a liquid chromatography system in which tubing carrying the chromatography system eluent can be coupled, for example, through ports such as ports 81 and/or through tubing such as tubing 89. Further, the flow cell module 80 may include a flow cell 84. In some embodiments, the instrument may comprise a photodiode array or other detector.

The flow cell 84 may be identifiable using a flow cell ID chip 85. The flow cell ID chip 85 may comprise an electrical contact/connector for connecting to a flow cell ID chip reader of the instrument (not shown), a radio frequency identification (RFID) chip, or other means of providing a flow cell ID. For example, various wired and un-wired connection and/or communication means may be used, including but not limited to physical contacts, RFID, Bluetooth, local area connection, and the like.

In embodiments, the flow cell module 80 may further include, or may be configured to interact with, a filter module 90. In embodiments, filter module 90 may include a filter holder 92 configured to hold an optical filter 98. Filter module 90 may also include a filter ID chip 95. As an example, the filter ID chip 95 may be positioned on an upper surface 92a of the filter holder 92. Like the flow cell ID chip 85, the filter ID chip 95 may comprise an electrical contact/connector for connecting to a flow cell ID chip reader of the instrument (not shown), a radio frequency identification (RFID) chip, or other means of providing a filter cell ID. For example, various wired and un-wired connection and/or communication means may be used, including but not limited to physical contacts, RFID, Bluetooth, local area connection, and the like.

In embodiments, the flow cell module 80 may further include a filter slot 89 for receiving the filter module 90 and/or components thereof, such as the filter holder 92 and/or the optical filter 98. Still further, in embodiments, the flow cell module 80 may also have a registration feature 94 for receiving the filter holder 92 and/or the optical filter 98. In embodiments, the registration feature 94 may be a rail or similar feature for guiding and/or receiving the filter holder 92 and positioning the filter holder 92 and optical filter 98 in an optical path and/or with respect to the flow cell 84.

Turning back to the filter module 90, a light-shield 93 may be provided to cover the filter slot 89 and prevent light from entering the flow cell module 80 and/or the instrument when the filter module 90 is inserted into the filter slot 89.

In embodiments, a filter, such as optical filter 98, can be incorporated anywhere between a lamp/light source and a flow cell, such as flow cell 84.

In the depicted embodiment, the filter module 90 is removable and/or exchangeable with respect to the flow cell module 80. Thus, a user may select a filter module 90 having an appropriate filter and/or may exchange a filter in the filter module 90/filter holder 92 for an appropriate filter. The user may remove/exchange the filter module 90 and optical filter 98 for different samples, different analytes, and the like.

Although not specifically shown in FIGS. 8A and 8B, it will be understood that the measurement instrument for which the flow cell module 80 and/or filter module 90 will be used may include various additional components, including components such as those shown in FIGS. 1A-1D, for example, a (broadband) light source, I.R. optics, dispersive optics, and/or detectors/sensor arrays. In embodiments, the filter such as filter 98 may be disposed on the optical axis of such components.

Still further, in embodiments, filter holders, such as filter holder 92, and/or registration features, such as registration feature 94, may be replaced by alternative structures. For example, in embodiments, the filter module 90 and/or the filter holder 92 may include a motorized mechanical assembly for selection of a filter, such a filter 98, from a plurality of filter options. For example, in such embodiments, a wheel with a plurality of filters may be provided and/or a motor position may act as a filter ID to identify the selected filter and provide information on the instrument configuration.

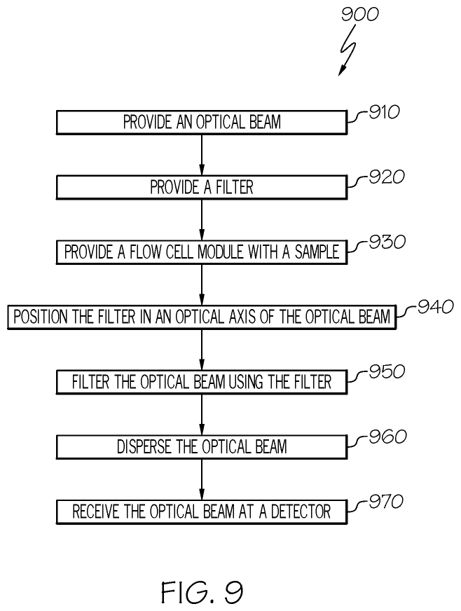

FIG. 9 depicts a method 900 for measuring absorbance of a sample in accordance with embodiments. The method 900 is an exemplary method and may be varied according to the embodiments described herein.

The method 900 includes a step 910 of providing an optical beam having a spectrum.

The method 900 includes a step 920 of providing a filter, such as optical filter 98. In embodiments, the filter may be provided with a filter holder, such as filter holder 92. In embodiments, the method 900 may include an optional step of providing filter identification information from the optical filter and/or from the filter holder, for example, from a filter ID chip or other feature.

The method 900 includes a step 930 of providing a flow cell module with a sample, such as flow cell module 80. In embodiments, the flow cell module may be configured to receive the filter holder having the filter.

The method 900 includes a step 940 of positioning the filter in an optical axis of the optical beam. In embodiments, the filter may be positioned prior to the sample, i.e., between a source of the optical beam and the sample.

The method 900 includes a step 950 of filtering the optical beam using the filter. Filtering the optical beam may generate a filtered optical beam having at least one of a reduced spectral width and an attenuated intensity. In embodiments, filtering the optical beam may include using a bandpass filter, a shortpass filter, a longpass filter, neutral density filter, and/or a linear variable edge pass filtering. Still further, in embodiments, the attenuated intensity comprises a substantially constant attenuation across a spectral width of the optical beam. In embodiments, filtering may provide reduced photodegradation of the sample and/or provide improved linearity of measured absorbance as discussed above. Further, in embodiments,

The method 900 includes step 960 of dispersing the optical beam. In embodiments, dispersing the filtered optical beam may comprise directing the optical beam to be incident on a diffraction grating.

The method 900 includes a step 970 of receiving the optical beam at a detector. In embodiments, the detector is a photodiode array.

The flowchart diagram of FIG. 9 illustrates the steps of possible implementations of methods according to various embodiments. It will be understood that features from the devices and applications discussed above may be incorporated into the method in some embodiments. Further, in some implementations, the steps noted may occur out of the order noted in the figure and discussed above. For example, two steps shown in succession may, in fact, be executed substantially concurrently, or the steps may sometimes be executed in the reverse order, depending upon the functionality involved.

While various examples have been shown and described, the description is intended to be exemplary, rather than limiting and it should be understood by those of ordinary skill in the art that various changes in form and detail may be made therein without departing from the scope of the invention as recited in the accompanying claims.

What is claimed is:

1. An absorbance detector, comprising:
a light source;
an optical filter;
a flow cell configured to hold a sample; and
a detector;
wherein the optical filter is positioned between the light source and the flow cell; and
wherein a dispersive element is provided between the light source and the detector.

2. The absorbance detector of claim 1, further comprising a filter holder for holding the optical filter.

3. The absorbance detector of claim 2, wherein the filter holder and/or the filter includes a filter ID chip configured to provide filter identification information regarding the filter.

4. The absorbance detector of claim 3, wherein the filter ID chip comprises an electrical connector configured for coupling to a further electrical connector to enable the filter identification information to be read from the filter ID chip.

5. The absorbance detector of claim 3, wherein the filter ID chip is a radio frequency identification (RFID) chip and wherein the filter identification information is stored on the RFID chip.

6. The absorbance detector of claim 1, wherein the dispersive element is a diffraction grating and/or wherein the filter is an ultraviolet blocking filter, a bandpass filter, a longpass filter, a shortpass filter, or a neutral density filter.

7. The absorbance detector of claim 3, wherein the filter holder and filter form a filter module.

8. The absorbance detector of claim 7, wherein the filter module is removable from the absorbance detector and/or the flow cell module.

9. The absorbance detector of claim 2, further comprising a filter slot for receiving the filter holder and/or the filter.

10. The absorbance detector of claim 1, wherein the flow cell is configured to pass a liquid chromatography system flow.

11. A method of measuring absorbance of a sample, the method comprising:
providing an optical beam having a spectrum;
providing a filter;
providing a flow cell module with a sample;
positioning the filter in an optical axis of the optical beam prior to the sample; and
filtering the optical beam using the filter to generate a filtered optical beam having at least one of a reduced spectral width and an attenuated intensity of the optical beam;
wherein the method further comprises dispersing the optical beam; and
receiving the optical beam at a detector.

12. The method of claim 11, wherein filtering the optical beam comprises one or more of bandpass filtering, shortpass filtering, longpass filtering, neutral density filtering, and linear variable edge pass filtering.

13. The method of claim 11, wherein spectrally dispersing the filtered optical beam comprises directing the filtered optical beam to be incident on a diffraction grating.

14. The method of claim 11, wherein the filtering provides reduced photodegradation of the sample and/or provides improved linearity of measured absorbance.

15. The method of claim 11, further comprising providing filter identification information from the filter and/or a filter holder holding the filter.

16. A flow cell module, comprising:
a module block configured to be connected to a measurement instrument;
a flow cell;
a filter slot; and
a registration feature;
wherein the filter slot is configured to receive a filter holder, and wherein the registration feature is configured to position the filter holder with respect to the flow cell.

17. The flow cell module of claim 16, further comprising:
the filter holder and at least one filter;
wherein the filter holder is removable from the filter slot, and/or wherein the filter holder holds a plurality of filters, and the at least one filter is selectable from the plurality of filters.

18. The flow cell module of claim 17, wherein the filter holder comprises a filter ID chip for providing information about the filter holder and/or the at least one filter.

19. The flow cell module of claim 16, wherein the flow cell comprises a flow cell ID chip for providing information about the flow cell.

20. The flow cell module of claim 16, wherein the registration feature is a rail for guiding the filter holder when the filter slot receives the filter holder.
